(19) United States
(12) Patent Application Publication
(10) Pub. No.: US 2005/0270989 A1
(43) Pub. Date: Dec. 8, 2005

(54) Method and apparatus for automatically configuring wireless network device

(75) Inventors: Jae-hyun Park, Suwon-si (KR); Jin-hyung Kim, Suwon-si (KR); Jin-tack Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/126,278

(22) Filed: May 11, 2005

(30) Foreign Application Priority Data
Jun. 2, 2004 (KR) 10-2004-0039980

(51) Int. Cl. H04L 12/28

(52) U.S. Cl. 370/254

(57) ABSTRACT

A method and apparatus for automatically configuring a wireless network device by receiving configuration information from a configuration information server that stores and provides the configuration information of the wireless network device are provided. The method includes: searching for service sets existing within range of the wireless network device and creating a list of the service sets; transmitting a request message requesting configuration information of the wireless network device to a configuration information server of each of the service sets using the list of the service sets; receiving a response message comprising the configuration information of the wireless network device from the configuration information server; and automatically configuring the wireless network device using the received configuration information.

### CROSS-REFERENCE TO RELATED APPLICATION

This application claims the benefit under 35 U.S. §119(a) of Korean Patent Application No. 10-2004-0039980, filed on Jun. 2, 2004, in the Korean Intellectual Property Office, the entire disclosure of which is hereby incorporated by reference.

### BACKGROUND OF THE INVENTION

1. Field of the Invention

The present invention relates to the configuration of a wireless network device. More particularly, the present invention relates to a method and an apparatus for automatically configuring a wireless network device by receiving configuration information from a configuration information server that stores and provides the configuration information of the wireless network device.

2. Description of the Related Art

A wireless network device, for example, a wireless printing device, can transmit and receive data to and from another wireless network device via a wireless network. In order for the wireless printing device to transmit and receive the data wirelessly to and from the other wireless network device, for example, a computer, the wireless printing device includes a wireless network module 100 as illustrated in FIG. 1 or a wireless network card. FIG. 1 is a block diagram of the conventional wireless network module 100.

As illustrated in FIG. 1, the conventional wireless network module 100 includes a central processing unit (CPU) 110, a read-only memory (ROM) 112, a random access memory (RAM) 114, a non-volatile memory (NVRAM) 116, an input/output interface unit 118, and a wireless communication module 120. The CPU 110 controls the operation of the wireless network module 100, and the ROM, RAM, and NVRAM memories 112, 114, and 116 store programs or data. The input/output interface unit 118 transmits and receives data to and from an external peripheral device, and the wireless communication module 120 communicates with another wireless network device via a wireless network 130.

Usually, for the wireless printing device to communicate with the other wireless network device, an operating mode is set. The operating mode may be an ad-hoc mode or an infrastructure mode. FIGS. 2 and 3 are structural diagrams illustrating the conventional ad-hoc mode and the conventional infrastructure mode, respectively.

As illustrated in FIG. 2, a wireless printing device 10 set in the ad-hoc mode may be directly connected to a peripheral wireless network device, for example, a laptop computer 22 or a computer 24. On the other hand, as illustrated in FIG. 3, a wireless printing device 10 set in the infrastructure mode may be connected to a wireless network device, for example, a laptop computer 38 via an access point 30, or connected using wires to computers 32, 34, and 36 via the access point 30. In addition, in order for the wireless printing device to communicate with the other wireless network device, the wireless printing device needs to set values for network identifiers and security measures, such as, a service set identifier (SSID) and a wired equivalent privacy (WEP).

As described above, when the wireless network device is included in a wireless network system, the user of the wireless network device experiences the inconvenience of having to repeat a complex set up process for the wireless network device. Further, the user needs to accurately know the configuration information of the network.

A typical method and a system for locating a wireless device that provides information about a location of the wireless device are disclosed in U.S. Patent Publication No. 2003-0142016. However, the cited reference does not discuss the configuration information of the wireless network device, as described above, and only discloses how to generate information regarding the location of the wireless device.

### SUMMARY OF THE INVENTION

The present invention provides a method of automatically configuring a wireless network device after receiving configuration information from a configuration information server that stores and provides the configuration information of the wireless network device.

The present invention also provides an apparatus for automatically configuring a wireless network device after receiving configuration information from a configuration information server that stores and provides the configuration information of the wireless network device.

The present invention also provides a configuration information server for storing and providing configuration information of a wireless network device for automatically configuring the wireless network device.

According to an aspect of the present invention, there is provided a method of automatically configuring a wireless network device so that the wireless network device can transmit and receive data to and from other wireless network devices near the wireless network device via a wireless network. The method comprises searching for service sets existing within range of the wireless network device and creating a list of the service sets; transmitting a request message requesting configuration information of the wireless network device to a configuration information server of each of the service sets using the list of the service sets; receiving a response message comprising the configuration information of the wireless network device from the configuration information server; and automatically configuring the wireless network device using the received configuration information.

According to another aspect of the present invention, there is provided an apparatus for automatically configuring a wireless network device so that the wireless network device can transmit and receive data to and from other wireless network devices near the wireless network device via a wireless network. The apparatus comprises a service set searcher for searching for service sets existing near the wireless network device and creating a list of the service sets; a request message transmitter for transmitting a request message that requests configuration information of the wireless network device to a configuration information server of each of the service sets by using the list of the service sets; a response message receiver for receiving a response message comprises the configuration information of the wireless network device from the configuration information server; and an automatic configuration unit for automatically configuring the wireless network device using the received configuration information.

According to yet another aspect of the present invention, there is provided a configuration information server for storing and providing configuration information of a wireless network device that transmits and receives data to and from other wireless network devices near the wireless network device via a wireless network. The configuration information server comprises a configuration information input unit for receiving the configuration information of the wireless network device from a user and storing the input configuration information; a request message receiver for receiving a request message requesting the configuration information from the wireless network device; a configuration information searcher for determining whether the configuration information of the wireless network device exists by using the request message; and a response message transmitter for transmitting a response message comprising the configuration information to the wireless network device if the configuration information of the wireless network device exists.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional wireless network module;

FIG. 2 is a structural diagram illustrating a conventional ad-hoc mode;

FIG. 3 is a structural diagram illustrating a conventional infrastructure mode;

FIG. 4 is a flowchart illustrating a method of automatically setting a wireless network device according to an embodiment of the present invention;

FIG. 5 is a flowchart illustrating the operation of a configuration information server according to an embodiment of the present invention;

FIG. 6 is a block diagram of the wireless network device and the configuration information server according to an embodiment of the present invention;

FIG. 7 is a view of an exemplary interface for inputting configuration information according to an embodiment of the present invention; and

FIGS. 8A through 8D illustrate messages displayed on a liquid crystal display device of a printer according to an embodiment of the present invention.

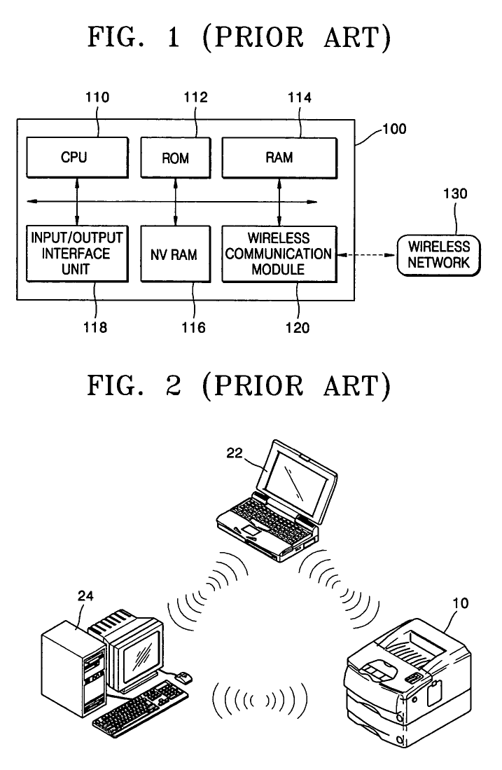

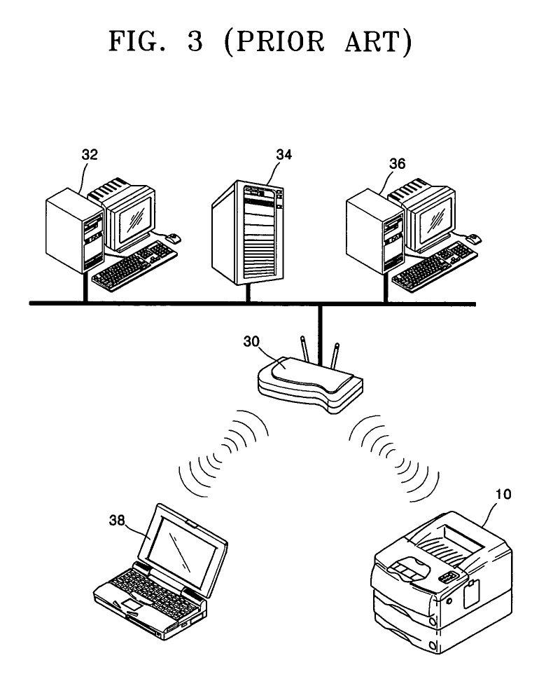

Throughout the drawings, it should be understood that like reference numbers will refer to similar features, structures, and elements.

### DETAILED DESCRIPTION OF EXEMPLARY EMBODIMENTS

The present invention will now be described more fully with reference to the accompanying drawings, in which exemplary embodiments of the invention are shown. Descriptions of well-known techniques or structures are omitted for the sake of clarity and conciseness. In addition, the terminology that follows is defined according to the functions of devices in the present invention and may change according to, for example, conventional usage or the intentions of a user or operator. Therefore, definitions should be derived based on the overall contents of the present application.

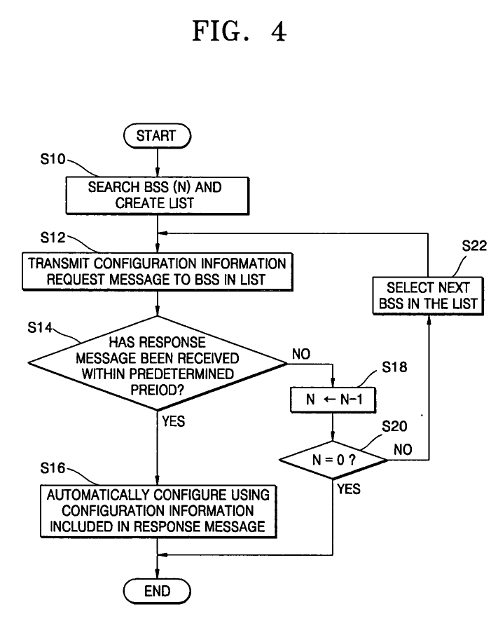

FIG. 4 is a flowchart illustrating a method of automatically setting a wireless network device according to an embodiment of the present invention. The wireless network device may be a wireless printing device. The wireless network device may be called a wireless station or a wireless node. A method of automatically setting the wireless printing device, for example, a printer, will now be described.

Referring to FIG. 4, when the printer is added to a wireless network system as a new device, the printer searches for service sets existing near the printer and creates a list of the service sets composed of service set identifiers and an operating mode (Operation S10). The operating mode may be an infrastructure mode or an ad-hoc mode. The service set is generally called a base service set (BSS). It is assumed that in Operation S10, N BSSes are found and included in the list of service sets.

A request message requesting the configuration information of the printer is transmitted from the printer to a configuration information server of one of the BSS in the list (Operation S12). The configuration information may also be called a profile. In addition, the configuration information server may also be called a profile server.

Next, it is determined whether a response message comprising the configuration information of the printer has been received from the configuration information server (Operation S14).

When the response message has not been received within a predetermined period, connection to the BSS is terminated. Then, in order to select the next BSS in the list of the found BSSes, N is set to equal N−1. That is, the number of found BSSes is reduced by one (Operation S18). Then, it is determined whether N is 0 (Operation S20). The process is terminated if it is determined that N is 0. That is, the process is terminated without receiving the response message comprising the configuration information of the printer. Alternatively, when N is 0, a list may be recreated by detecting the BSSes again. Meanwhile, when it is not determined that N is 0 in Operation S20, the next BSS in the list is selected (Operation S22) and Operation S12 is repeated.

When it is determined that the response message has been received in Operation S14, the printer is automatically configured using the configuration information of the printer included in the response message (Operation S16). In addition, the printer is made one of the wireless nodes of the BSS by going through an authentication and association processes.

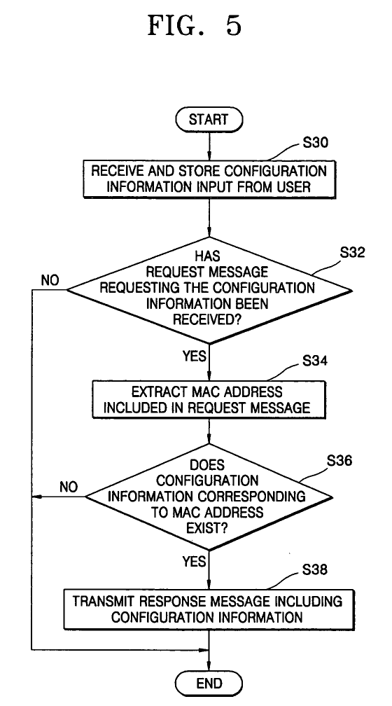

FIG. 5 is a flowchart illustrating the operation of the configuration information server according to an embodiment of the present invention. Referring to FIG. 5, the configuration information server receives the configuration information of the printer from a user and stores the inputted configuration information (Operation S30). The configuration information of the printer which the user inputs may include a media access control (MAC) address of the printer. Further, when the BSS including the configuration information server is operating in the infrastructure mode, the configuration information server may be an access point (AP).

The configuration information server determines whether a request message requesting the configuration information transmitted from the printer has been received (Operation S32). When a message requesting the configuration information has not been received, the process is terminated.

When it is determined that the request message requesting the configuration information has been received in Operation S32, the MAC address of the printer, which is preferably included in the request message, is extracted (Operation S34). The configuration information server searches the configuration information stored in the configuration information server using the MAC address of the printer, and determines whether the configuration information corresponding to the MAC address of the printer exists (Operation S36). If the configuration information corresponding to the MAC address of the printer does not exist, the process is terminated.

If the configuration information corresponding to the MAC address of the printer does exist, a response message comprising the configuration information of the printer is transmitted to the printer (Operation S38).

FIG. 6 is a block diagram of a wireless network device 10 and a configuration information server 40. The wireless network device 10 includes a wireless printing device, for example, a printer. An apparatus for automatically configuring the wireless printing device and a configuration information server 40 will now be described. The apparatus for automatically setting the printer may be included in the printer 10.

Referring to FIG. 6, the printer 10 comprises a service set searcher 12, a request message transmitter 14, a response message receiver 16, and an automatic configuration unit 18. The configuration information server 40 comprises a configuration information input unit 42, a request message receiver 44, a configuration information searcher 46, and a response message transmitter 48.

The service set searcher 12 searches for service sets existing near the printer and creates a list. The request message transmitter 14 transmits a request message to the configuration information server 40 of each service set included in the list of the service sets requesting configuration information of the printer. The request message may include the MAC address of the printer.

The response message receiver 16 receives the response message comprising the configuration information of the printer from the configuration information server 40. The automatic configuration unit 18 automatically configures the printer using the received configuration information.

Meanwhile, the configuration information input unit 41 of the configuration information server 40 receives the configuration information of the wireless network device 10, for example, the printer, from a user and stores the inputted configuration information. The configuration information input to the configuration information input unit 42 may include the MAC address of the printer 10.

The request message receiver 44 receives the request message requesting the configuration information from the printer 10. The request message may include the MAC address of the printer 10.

The configuration information searcher 46 determines whether the configuration information of the printer 10 exists using information from the request message. The configuration information searcher 46 may search for the configuration information of the wireless network device 10 stored in the configuration information server 40 using the MAC address of the printer 10 that may be included in the received request message. The response message transmitter 48 transmits a response message to the printer 10 if the configuration information of the printer 10 exists.

When the BSS including the configuration information server 40 therein is operating in the infrastructure mode, the configuration information server 40 may be an access point.

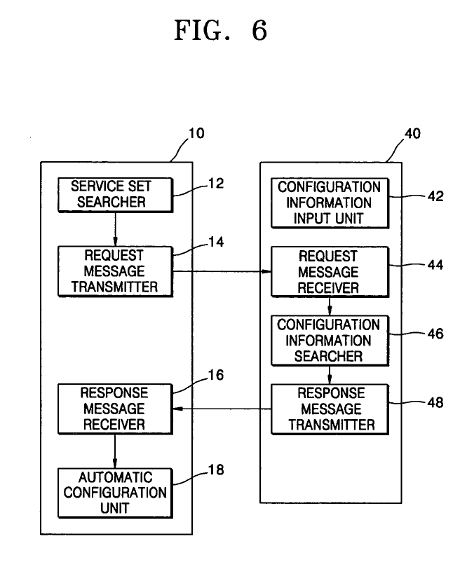

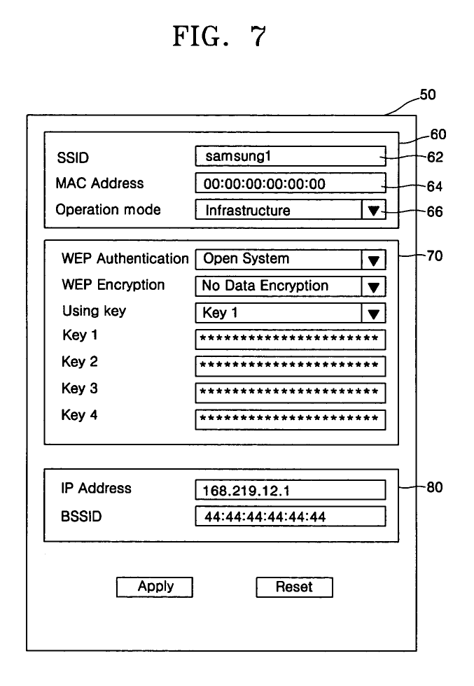

FIG. 7 is a view of an exemplary interface for inputting the configuration information according to an embodiment of the present invention. For example, in a web browser, when selecting features a menu may be displayed for inputting the configuration information by connecting to the configuration information server 40 via an Internet Protocol (IP) address of the profile server or the configuration information server 40, the interface 50 illustrated in FIG. 7 may be displayed.

The user of the printer 10 who wants to store the configuration information of the printer 10 in the configuration information server 40 inputs the configuration information of the printer 10. The user may complete the inputting of the configuration information by simply inputting the MAC address of the printer 10 because information other than the MAC addresses included in the configuration information is generally provided by the configuration information server 40.

In more detail, a section 60 in which basic information is input comprises input fields and menus in which a service set identifier (SSID) 62, a MAC address 64, and an operating mode 66 are either inputted or selected. The SSID 62 is the name of the service set, in which the configuration information server 40 is preferably included. The operating mode 66 may be selected from one of the infrastructure mode and the ad-hoc mode. The SSID 62 and the operating mode 66 are determined by the service set in which the configuration information server 40 is included. In addition, a section 70 in which network security information related to wired equivalent privacy (WEP) or other suitable network security information is input and an IP address inputting section 80 are determined by the service set.

As described-above, in order for the user to input the configuration information of the wireless network device 10, which may include for example, the printer 10, to the configuration information server 40, the user should input the MAC address of the printer 10. Conventionally, the user must input complex configuration information to configure a wireless network device. However, in an embodiment of the present invention, only the MAC address of the printer 10 must be input. That is, conventionally, complex configuration information, such as the SSID, the operating mode, and the information related to WEP had to be input to set a wireless configuration. However, in an embodiment of the present invention, the wireless network device 10 can be automatically configured by pre-inputting only the MAC address of the wireless network device 10 to the configuration information server 40.

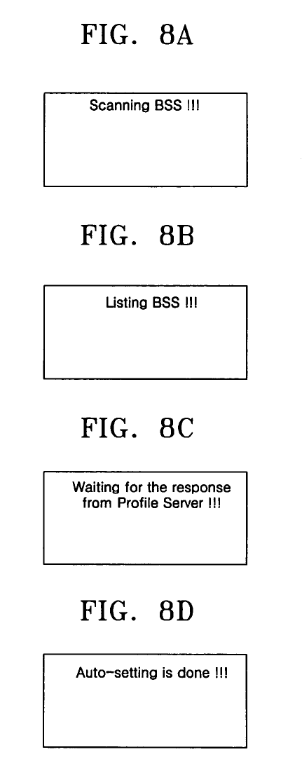

FIGS. 8A through 8D illustrate messages displayed on a liquid crystal display device of the printer 10 when automatically configuring the wireless network device 10, which includes the printer 10. FIG. 8A is preferably a message shown right after booting up the printer 10. It is a message denoting that the printer 10 is scanning for the BSS. FIG. 8B is preferably a message denoting that the list of the searched BSS is being created. FIG. 8C is preferably a message denoting that the wireless network device 10 is waiting for a response from the profile server after a request message for the configuration information has been transmitted to one of the BSSes. FIG. 8D is preferably a message denoting the completion of the automatic configuration of the printer 10 after receiving the response message, which preferably includes the configuration information, from the profile server.

As described-above, repeatedly configuring a wireless network device may be avoided when using an embodiment of the present invention. Also, the configuring of the wireless network device can be easily changed and set.

While an embodiment of the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of automatically configuring a wireless network device so that the wireless network device can transmit and receive data to and from other wireless network devices near the wireless network device via a wireless network, the method comprising:
searching for service sets existing within range of the wireless network device and creating a list of the service sets;
transmitting a request message requesting configuration information of the wireless network device to a configuration information server of each of the service sets using the list of the service sets;
receiving a response message comprising the configuration information of the wireless network device from the configuration information server; and
automatically configuring the wireless network device using the received configuration information.

2. The method of claim 1, wherein the wireless network device comprises a wireless printing device.

3. The method of claim 1, further comprising the steps of: receiving configuration information of the wireless network device from a user and storing the inputted configuration information on the configuration information server.

4. The method of claim 3, wherein the configuration information of the wireless network device input by the user comprises a media access control address of the wireless network device.

5. The method of claim 1, further comprising the step of:
searching the configuration information stored in the configuration information server using a media access control address of the wireless network device included in the received request message.

6. The method of claim 1, further comprising the step of:
transmitting from the configuration information server the response message to the wireless network device if configuration information corresponding to a media access control address of the wireless network device exists.

7. An apparatus for automatically configuring a wireless network device so that the wireless network device can transmit and receive data to and from other wireless network devices near the wireless network device via a wireless network, the apparatus comprising:
a service set searcher for searching for service sets existing within range of the wireless network device and creating a list of the service sets;
a request message transmitter for transmitting a request message that requests configuration information of the wireless network device to a configuration information server of each of the service sets by using the list of the service sets;
a response message receiver for receiving a response message including the configuration information of the wireless network device from the configuration information server; and
an automatic configuration unit for automatically configuring the wireless network device using the received configuration information.

8. The apparatus of claim 7, wherein the wireless network device comprises a wireless printing device.

9. The apparatus of claim 7, wherein the request message comprises a media access control address of the wireless network device.

10. A configuration information server for storing and providing configuration information of a wireless network device that transmits and receives data to and from other wireless network devices within range of the wireless network device via a wireless network, the configuration information server comprising:
a configuration information input unit for receiving the configuration information of the wireless network device from a user and storing the input configuration information;
a request message receiver for receiving a request message requesting the configuration information from the wireless network device;
a configuration information searcher for determining whether the configuration information of the wireless network device exists by using the request message; and
a response message transmitter for transmitting a response message including the configuration information to the wireless network device if the configuration information of the wireless network device exists.

11. The configuration information server of claim 10, wherein the wireless network device comprises a wireless printing device.

12. The configuration information server of claim 10, wherein the configuration information input to the configuration information input unit comprises a media access control address of the wireless network device.

13. The configuration information server of claim 10, wherein the request message comprises a media access control address of the wireless network device, and the configuration information searcher searches the configuration information of the wireless network device stored in the configuration information server using the media access control address of the wireless network device.

14. The configuration information server of claim 10, wherein the configuration information server comprises an access point.
